(19) United States
(12) Patent Application Publication
(10) Pub. No.: US 2026/0088570 A1
(43) Pub. Date: Mar. 26, 2026

(54) CONNECTOR AND DISPLAY DEVICE INCLUDING THE SAME

(71) Applicant: SAMSUNG ELECTRONICS CO., LTD., Suwon-si (KR)

(72) Inventors: Jongheon LEE, Suwon-si (KR); Byungjin LEE, Suwon-si (KR)

(73) Assignee: SAMSUNG ELECTRONICS CO., LTD., Suwon-si (KR)

(21) Appl. No.: 19/232,387

(22) Filed: Jun. 9, 2025

Related U.S. Application Data
(63) Continuation of application No. PCT/KR2025/007267, filed on May 28, 2025.

(30) Foreign Application Priority Data
Sep. 20, 2024 (KR) 10-2024-0127292

(51) Int. Cl. H01R 13/639; G06F 1/18; H01R 12/70; H01R 12/79; H01R 43/26

(52) U.S. Cl. CPC H01R 13/639; G06F 1/183; H01R 12/7005; H01R 12/7076; H01R 12/79; H01R 43/26; H01R 2201/06

(57) ABSTRACT

A display device includes: a display module; a printed circuit board electrically connected to the display module; a connector on the printed circuit board; and a cable extending from the display module and connected to the connector, wherein the cable comprises a plurality of cable terminals and a guideline portion positioned at an end portion of the cable and on a side of the connector, wherein the connector comprises: a housing including a bottom portion contacting the printed circuit board and a wall portion extending upward from the bottom portion and being adjacent to the guideline portion, and a locking member pivotally coupled to the housing about a rotation axis (R), and wherein an edge of the locking member adjacent to the rotation axis (R) is spaced apart from the wall portion by a first distance (D2).

### CROSS-REFERENCE TO RELATED APPLICATIONS

This application is a continuation of an International application No. PCT/KR2025/007267 designating the United States, filed on May 28, 2025, in the Korean Intellectual Property Receiving Office, which claims priority from Korean Patent Application No. 10-2024-0127292, filed on Sep. 20, 2024, in the Korean Intellectual Property Office, the disclosures of each of which are incorporated by reference herein in their entireties.

### BACKGROUND

### 1. Field

One or more embodiments of the disclosure relate to a connector and a display device including the connector, and relate to a connector having a structure capable of detecting a fastening failure of a flat cable and a display device including the connector.

### 2. Description of Related Art

A display device visually converts and displays electrical information to the user. The display device may be included in various portable terminal devices, such as smartphones and tablet PCs, as well as televisions and monitor devices.

As display devices grow in size or improve in resolution, the display devices include more display modules. As more display modules are added, the number of cables, such as flexible flat cables, increases.

The above-described information may be provided as related art for the purpose of helping understanding of the disclosure. No claim or determination is made as to whether any of the foregoing is applicable as background art in relation to the disclosure.

### SUMMARY

According to an aspect of the disclosure, a display device includes: a display module; a printed circuit board electrically connected to the display module; a connector on the printed circuit board; and a cable extending from the display module and connected to the connector, wherein the cable comprises a plurality of cable terminals and a guideline portion positioned at an end portion of the cable and on a side of the connector, wherein the connector comprises: a housing including a bottom portion contacting the printed circuit board and a wall portion extending upward from the bottom portion and being adjacent to the guideline portion, and a locking member pivotally coupled to the housing about a rotation axis (R), and wherein an edge of the locking member adjacent to the rotation axis (R) is spaced apart from the wall portion by a first distance (D2).

According to an aspect of the disclosure, A display device includes: a display module; a printed circuit board electrically connected to the display module; a connector on the printed circuit board; and a cable extending from the display module and connected to the connector, wherein the cable comprises a plurality of cable terminals and a guideline portion positioned at an end portion of the cable and on a side of the connector, wherein the connector comprises: a housing including a bottom portion contacting the printed circuit board and a wall portion extending upward from the bottom portion and being adjacent to the guideline portion; and a locking member pivotally coupled to the housing about a rotation axis (R), wherein an edge of the locking member adjacent to the rotation axis (R) is spaced apart from the wall portion by a first distance (D2) to form a first gap, and wherein the housing further comprises a marking portion marked on an upper surface of the bottom portion to at least partially and vertically overlap the first gap.

According to an aspect of the disclosure, a connector to which a cable including a plurality of cable terminals is connected, includes: a housing comprises a bottom portion on which a plurality of first terminals are disposed, and a wall portion extending upward from an edge of the bottom portion; and a locking member pivotally coupled to the housing about a rotation axis (R), wherein the edge of the locking member adjacent to the rotation axis (R) is spaced apart from the wall portion by a first distance (D2).

Effects achievable in example embodiments of the disclosure are not limited to the above-mentioned effects, but other effects not mentioned may be derived and understood by one of ordinary skill in the art to which example embodiments of the disclosure pertain, from the following description. In other words, unintended effects in practicing embodiments of the disclosure are also be derived by one of ordinary skill in the art from example embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a display according to an embodiment;

FIG. 2 is a view illustrating a rear surface of a display module of a display device according to an embodiment;

FIG. 3 is a perspective view illustrating a connector and a cable according to an embodiment′

FIGS. 4 and 5 are plan views illustrating a connector according to an embodiment;

FIGS. 6 and 7 are side views illustrating a connector according to an embodiment;

FIGS. 8 and 9 are plan views illustrating a connector according to an embodiment; and

FIG. 10 is a side view illustrating a connector according to an embodiment.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

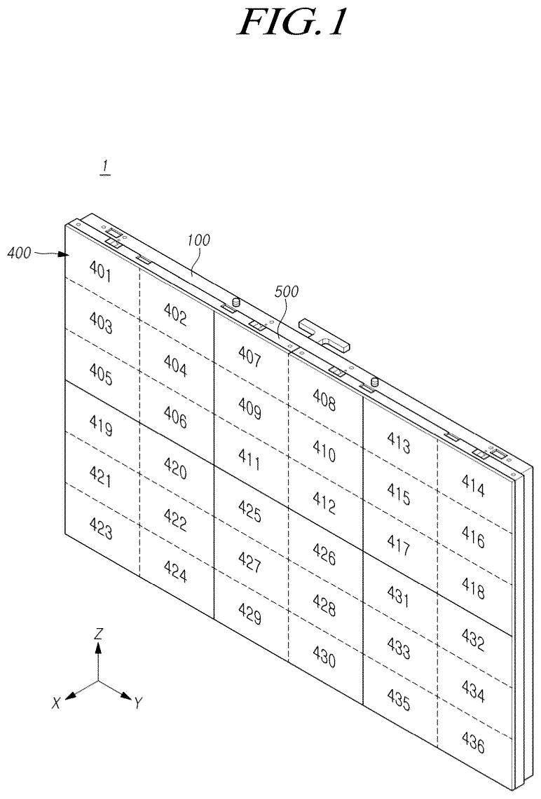

One or more embodiments of the disclosure are merely exemplified herein with reference to FIGS. 1 to 10, to describe the principle of the disclosure, and should not be interpreted as limiting the scope of the disclosure. Those skilled in the art will understand that the principle of the disclosure may be implemented in any appropriately disposed system or device.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

FIG. 1 is a perspective view illustrating a display device according to an embodiment.

Referring to FIG. 1, the display device 1 can show information or data in various forms such as characters, figures, graphs, videos, and images. The display device 1 may include a television, a PC monitor, a mobile device, or a digital signage. The display device 1 may be installed to be supported on the ground by a stand or may be installed to be supported on the wall.

According to an embodiment, the display device 1 may include a main body 100 and a plurality of display modules 400 installed on the main body 100. Each of the plurality of display modules 400 may be disposed in the support frame 500 disposed in the main body 100. The support frame 500 may be coupled to the front of the main body 100.

According to an embodiment, the plurality of display modules 400 may be liquid crystal display (LCD) modules, organic light emitting diode (OLED) display modules, micro LED display modules, LED display modules, E-Ink display modules, or quantum-dot display modules. Here, the display module 400 may be referred to as a modular display.

According to an embodiment, the main body 100 may form a portion of the exterior of the display device 1. According to an embodiment, a portion of the support frame 500 may be exposed to the outside. However, the disclosure is not limited to the above example embodiment, and the support frame 500 may be disposed in the main body 100 and may not be visually exposed to the outside. The main body 100 and the support frame 500 may be integrally formed.

According to an embodiment, a plurality of display modules 400 disposed in the support frame 500 may implement a screen of the display device 1.

According to an embodiment, a plurality of display modules 400 may be disposed in the form of an M*N matrix vertically and horizontally, so as to be adjacent to each other. For example, 36 display modules 400 may be disposed in the support frame 500 in the form of a 6*6 matrix as illustrated. For example, the first through thirty-sixth display modules 401 to 436 may be disposed in the support frame. However, the disclosure is not limited to the above example embodiment, and the number or arrangement of the plurality of display modules 400 may be varied.

According to an embodiment, at least one of the plurality of display modules 400 may have a flat shape or a curved shape. For example, the curved display module 400 may be a variable curvature.

According to an embodiment, the plurality of display modules 400 may be coupled to be detachable from the main body 100.

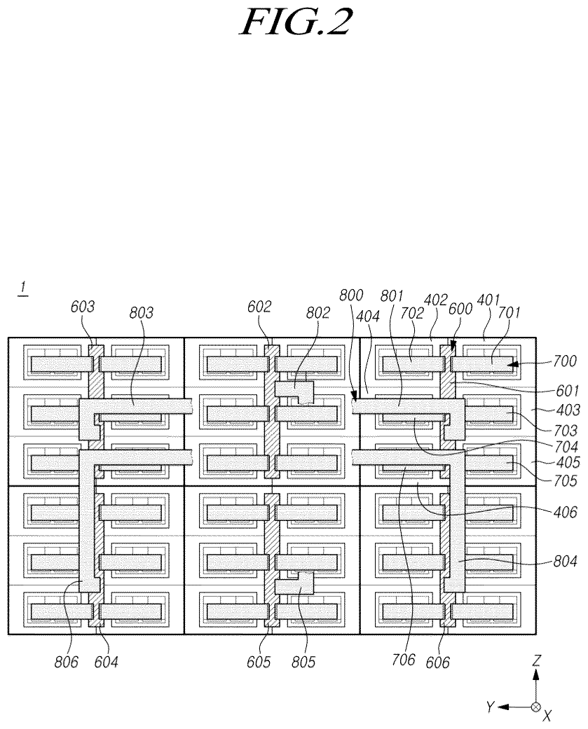

FIG. 2 is a view illustrating a rear surface of a display module of a display device according to an embodiment.

The configuration illustrated in FIG. 2 may constitute a portion of the display device 1 of FIG. 1. Electronic components such as a timing controller (TCON) or a main processor provided to control the plurality of display modules 400 are omitted in FIG. 2.

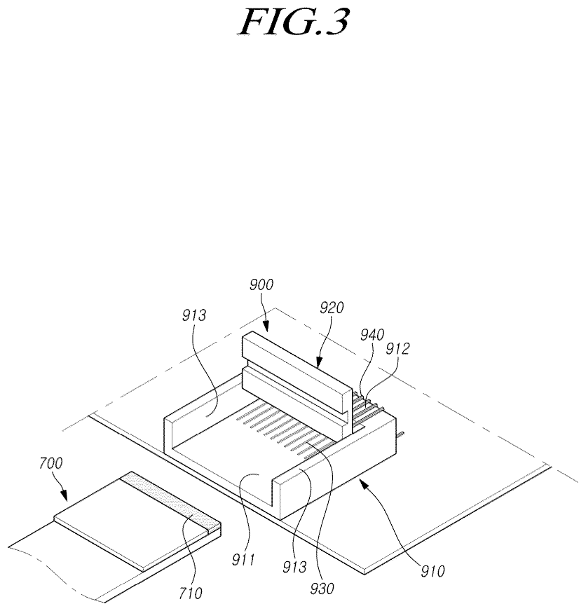

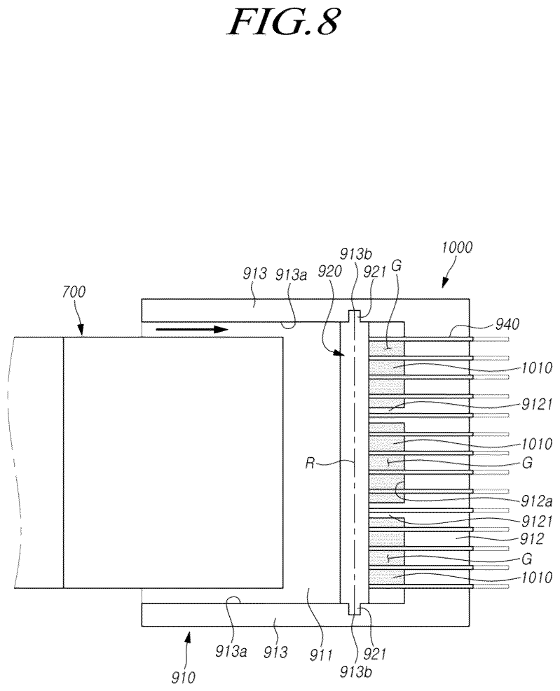

According to an embodiment, the display device 1 may include a cable 700 extending from the display module 400. The cable 700 may be electrically connected to a circuit in the display device 1. The cable 700 may be individually disposed to be electrically connected to each of the plurality of display modules 400. A plurality of cables may be disposed in the display device 1, and here, as the number of display modules 400 provided in the display device 1 increases, the number of cables 700 may increase. A connection failure may occur in the process of connecting the cable 700 to a connector (e.g., the connector 900 of FIG. 3 or the connector 1000 of FIG. 8), and as the number of cables 700 disposed in the display device 1 increases, the frequency of connection failure may also increase. In particular, since the number of cables 700 is larger in the display device 1 including the display modules 400 than in other display devices, it is necessary to quickly and accurately grasp the connection or fastening failure between the cable 700 and the connector 900 or 1000 in the manufacturing process. In the disclosure, a worker (or a user) may accurately and quickly determine whether the connection between the cable 700 and the connector 900 or 1000 is defective even with the naked eye by the connector 900 or 1000 having a structure to be described below.

According to an embodiment, the cable 700 may be connected to or fastened to the connector 900 or 1000. The cable 700 may be connected to the connector 900 or 1000 to be electrically connected to other electronic components. Here, the cable 700 may include a flexible flat cable (FFC), but the disclosure is not limited to the above example embodiment.

According to an embodiment, the display device 1 may include a printed circuit board (PCB). A plurality of PCBs may be provided in the display device 1 to mount electronic components such as a processor, a TCON, and a memory. For example, the PCB may include various types of boards, such as a main board, a graphics card or a graphics processing unit (GPU), a controller board, or an interface board.

According to an embodiment, the display device 1 may include a bridge board 600 that may be a PCB. The bridge board 600 may be electrically connected to the plurality of display modules 400. The bridge board 600 may connect the plurality of display modules 400 to a control component such as a processor or a TCON in the display device 1.

According to an embodiment, the number of bridge boards 600 disposed on the display device 1 may increase in proportion to the number of display modules 400. For example, in the case of a display device 1 equipped with 36 display modules 400 as illustrated, the first to sixth bridge boards 601 to 606 may be disposed.

According to an embodiment, the six display modules 400 may be electrically connected to one bridge board 600. For example, the first bridge board 601 may be electrically connected to the first to sixth display modules 401 to 406. For example, the second bridge board 602 may be electrically connected to the seventh to twelfth display modules 407 to 412. For example, the third bridge board 603 may be electrically connected to the thirteenth to eighteenth display modules 413 to 418. For example, the fourth bridge board 604 may be electrically connected to the 19th to 24th display modules 419 to 424. For example, the fifth bridge board 605 may be electrically connected to the 25th to 30th display modules 425 to 430. For example, the sixth bridge board 606 may be electrically connected to the 31st to 36th display modules 431 to 436. However, this is exemplary, and the number of display modules 400 connected to one bridge board 600 may vary.

According to an embodiment, the cable 700 and the bridge board 600 may be electrically connected to each other by a connector (e.g., the connector 900 of FIG. 3 or the connector 1000 of FIG. 8) to be described below.

According to an embodiment, the bridge board 600 may be omitted when the display modules 400 are configured as a single one or the number of display modules is small.

According to an embodiment, the display device 1 may include a bridge cable 800 extending from the bridge board 600. One bridge cable 800 may be disposed on each of a plurality of bridge boards 600. For example, first to sixth bridge cables 801 to 806 may be electrically connected to the first to sixth bridge boards 601 to 606, respectively.

According to an embodiment, the bridge cable 800 may be connected or fastened to the connector 900 or 1000 disposed on various types of boards such as a main board, a graphic card or GPU, a controller board or an interface board. For example, the bridge cable 800 may be electrically connected to the TCON. For example, the bridge cable 800 may be electrically connected to a main processor including a processing circuit. For example, as the bridge cable 800 is electrically connected to a control device such as a TCON or main processor, the display module 400 may be electrically connected to the TCON and/or main processor.

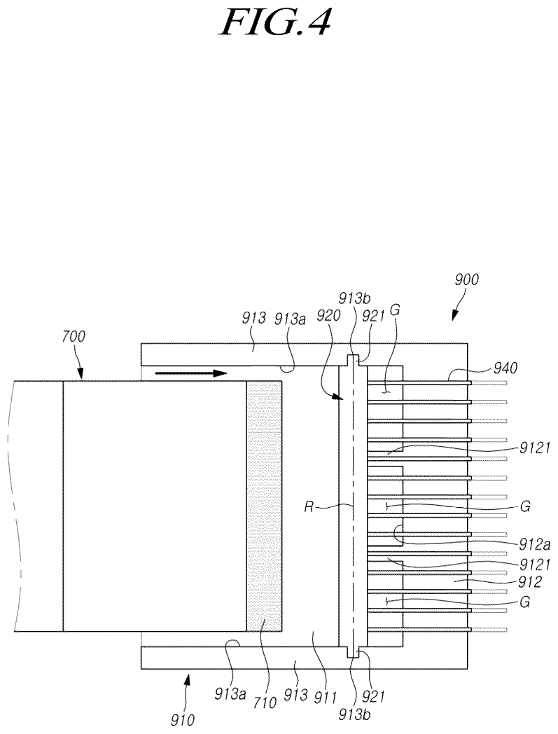

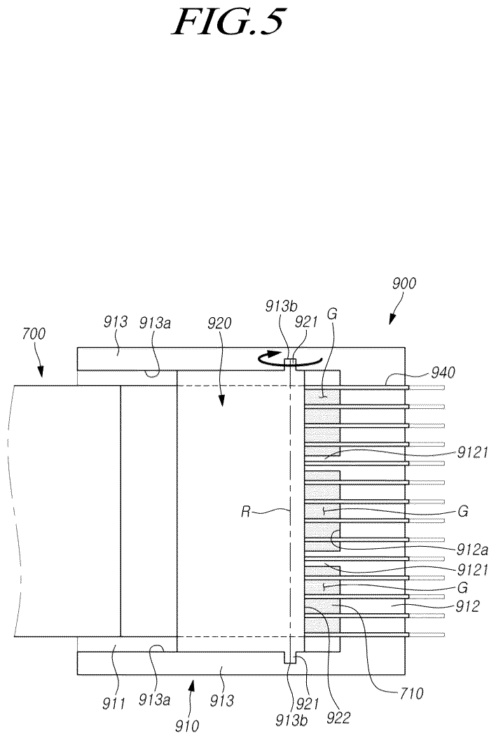

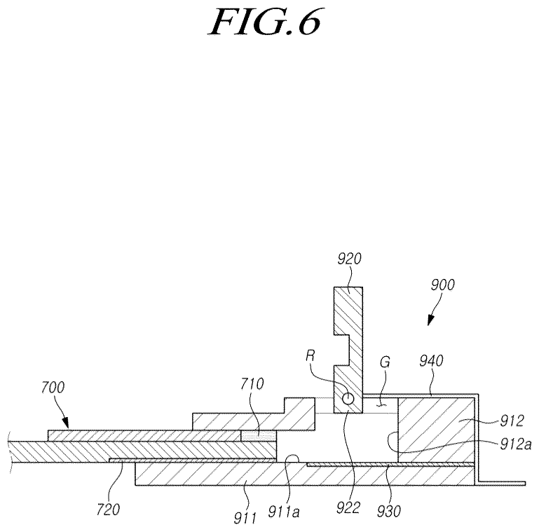

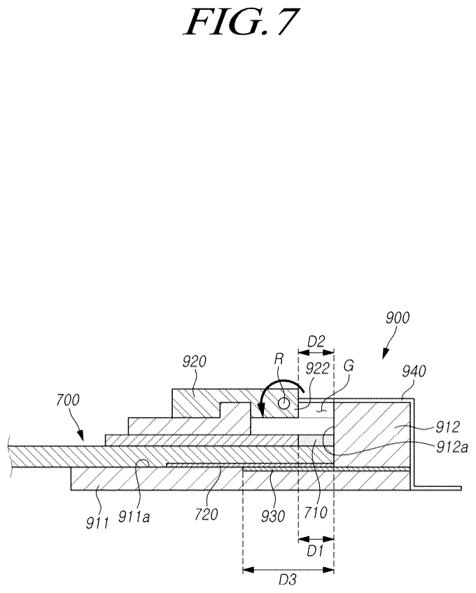

FIG. 3 is a perspective view illustrating a connector and a cable according to an embodiment. FIGS. 4 and 5 are plan views illustrating a connector according to an embodiment. FIGS. 6 and 7 are side views illustrating a connector according to an embodiment.

The connector 900 of FIGS. 3 to 7 may be included in the display device 1 of FIGS. 1 and 2. However, the disclosure is not limited to the above example embodiment, and the connector 900 of FIGS. 3 to 7 may be disposed in the electronic device to connect a cable (e.g., a flexible flat cable) in various types of electronic devices.

The embodiments of FIGS. 3 to 7 may be selectively combined with the embodiments of FIGS. 1 and 7. The embodiments of FIGS. 3 to 7 may be selectively combined with the embodiments of FIGS. 8 to 10.

In FIGS. 3 to 7, the cable 700 extending from the display module (e.g., the display module 400 of FIG. 2) is described as an example, but the disclosure is not limited to the example embodiment, and may also be applied to a bridge cable (e.g., the bridge cable 800 of FIG. 2) extending from the bridge board (e.g., the bridge board 600 of FIG. 2). The structure of the connector 900 described in connection with FIGS. 3 to 7 may be disposed on various types of circuit boards. As a cable coupled to the connector 900 disposed on various types of circuit boards, the cable 700 described in connection with FIGS. 3 to 7 may be applied.

Referring to FIGS. 3 to 7, an electronic device such as a display device (e.g., the display device 1 of FIG. 1) may include a cable 700 and a connector 900. The structures of the illustrated cable 700 and the connector 900 may be included in various types of electronic devices as well as the display device. For example, an electronic device where a flexible flat cable is disposed may include the connector 900 illustrated in FIGS. 3 to 7.

According to an embodiment, the connector 900 may be disposed on the PCB. The connector 900 may be fixed on the PCB. The connector 900 may be electrically connected to other electronic components mounted on the PCB.

According to an embodiment, the cable 700 may include a cable terminal 720. There may be a plurality of cable terminals 720. The cable terminal 720 may be disposed on the lower surface of the cable 700, for example. When the cable 700 is connected to the connector 900, the cable terminal 720 may contact the first terminal 930 of the connector 900. The cable 700 and the connector 900 may be electrically connected by contacting the cable terminal 720 and the first terminal 930. The plurality of cable terminals 720 may be electrically connected to a plurality of first terminals 930. Each of the plurality of cable terminals 720 may be disposed to contact each of the plurality of first terminals 930 in a one-to-one relationship.

According to an embodiment, the cable 700 may include a guideline portion 710. The guideline portion 710 may be formed or printed along an end edge of the cable 700. The guideline portion 710 may be formed or printed on the cable terminal-side edge of the cable 700. The guideline portion 710 may extend along one surface of the edge of the cable 700. The guideline portion 710 may be positioned to contact the edge of the longitudinal end portion of the cable 700. The guideline portion 710 may be positioned at an end portion of the cable 700 and on the fastening side of the connector 900.

According to an embodiment, the guideline portion 710 may be marked or printed in a specific color. For example, the guideline portion 710 may be shown in a high-contrast color compared to the surrounding components so that the worker or vision sensor may easily identify whether the cable 700 and the connector 900 are connected or fastened normally. For example, the guideline portion 710 may be shown or printed in yellow, red, orange, fluorescent, white, or the like. However, the disclosure is not limited to the above example embodiment, and the guideline portion 710 may be shown in a high-contrast color according to the color of the connector 900.

Generally, there have been various types of indication lines for workers to verify the proper connection between cables and connectors. However, these indication lines are shown at regular intervals from the end portion of the cable in the length direction or colored with a thick width from the edge of the end portion of the cable in the length direction. In this case, due to the tolerance generated when coating or applying the indication lines on the cable, the indication portions for the guide lines may be abnormally coated or applied, or the positions of the indication portions shown for each cable may not be constant. If the positions of the indication lines are misaligned, the worker may not identify whether they are normally fastened based on the indication lines.

In the disclosure, the guideline portion 710 is provided at a position in contact with the end edge of the cable 700. Thus, by changing the structure of the connector 900, the worker or the electronic device using the vision sensor may more easily and accurately determine whether the cable 700 and the connector 900 are connected normally even when there is some inclination or deformation due to tolerance when the machine forms the guideline portion 710.

According to an embodiment, the connector 900 may include a housing 910 and a locking member 920. The housing 910 may be a portion coupled to the PCB. The locking member 920 may be rotatably or pivotally coupled with respect to the housing 910. The locking member 920 may be configured to fix the cable 700 inserted onto the housing 910.

According to an embodiment, the locking member 920 may be coupled to the housing 910 to be rotatable between a first position (or a first rotation position) and a second position (or a second rotation position). The first position may be referred to as, e.g., an opened position. The second position may be referred to, e.g., as a closed position. For example, the first position may refer to a position of the locking member 920 illustrated in FIGS. 4 and 6. The second position may refer to a position of the locking member 920 illustrated in FIGS. 5 and 7.

According to an embodiment, the locking member 920 may rotate between the first position and the second position around the rotation axis R. The locking member 920 may be coupled to the housing 910 to be rotatable about the rotation axis R.

According to an embodiment, after the cable 700 is inserted into the housing 910, the locking member 920 is rotated from the first position to the second position, thereby fixing the cable 700. The locking member 920 may prevent the cable 700 from being separated from the connector 900.

According to an embodiment, the housing 910 may include a bottom portion 911, a wall portion 912, and a pair of side portions 913. The bottom portion 911, the wall portion 912, and the pair of side portions 913 may be integrally formed, but the disclosure is not limited to the above example embodiment.

According to an embodiment, the bottom portion 911 may be a portion in contact with the PCB. The bottom portion 911 may be positioned under the cable 700 and may be disposed to support the end portion of the cable 700. When the cable 700 is connected to the connector 900, the lower surface of the cable 700 may contact the bottom portion 911. The cable 700 may be inserted into the housing 910 along the upper surface 911a of the bottom portion 911.

According to an embodiment, the wall portion 912 may extend upward from the bottom portion 911. The wall portion 912 may extend upward from an edge of the bottom portion 911. The wall portion 912 may be positioned adjacent to the guideline portion 710 of the cable 700 to be described below. For example, when the cable 700 is fastened to the connector 900, the guideline portion 710 may be disposed adjacent to the wall portion 912.

According to an embodiment, the pair of side portions 913 may be formed to extend from two opposite ends of the wall portion 912. The pair of side portions 913 may be formed to face each other. The pair of side portions 913 may vertically extend upward from the bottom portion 911.

According to an embodiment, each of the pair of side portions 913 may include a fastening recess 913b. The fastening recess 913b may be formed in the inner side surface 913a of the side portion 913. The fastening recesses 913b provided in the side portions 913 may be positioned to face each other. The pair of fastening recesses 913b may be formed at a predetermined distance from the wall portion 912.

According to an embodiment, the locking member 920 may include a pair of fastening protrusions 921. The locking member 920 may be coupled to the housing 910 by fastening a pair of fastening protrusions 921 to the fastening recesses 913b.

According to an embodiment, the rotation axis R of the locking member 920 may be formed to extend in a direction parallel to the length direction of the wall portion 912. The rotation axis R may be positioned to overlap a virtual line connecting the pair of fastening protrusions 921 facing each other. The rotation axis R may be defined by the pair of fastening protrusions 921.

According to an embodiment, the rotation axis R of the locking member 920 may be positioned to extend in a direction parallel to the length direction of the wall portion 912. The rotation axis R may be positioned at a position spaced apart from the wall portion 912 by a first distance D2 or more.

According to an embodiment, the locking member 920 may be spaced apart from the wall portion 912 of the housing 910 by the first distance D2. For example, the first edge 922 adjacent to the rotation axis R of the locking member 920 may be spaced apart from the wall portion 912 by a first distance D2. A gap G may be formed between the first edge 922 and the wall portion 912. A width of the gap G may be substantially the same as the first distance D2.

According to an embodiment, the width D1 of the guideline portion 710 may be equal to or longer than the first distance D2. Here, the width D1 may refer to the length of the guideline portion 710 measured along the length direction of the cable 700.

According to an embodiment, when the cable 700 is normally connected or normally fastened to the connector 900, the guideline portion 710 may be disposed adjacent to the wall portion 912 of the housing 910.

According to an embodiment, the housing 910 may further include a supporting member 9121 that may extend from the wall portion 912. The supporting member 9121 may extend from the inner surface 912a of the wall portion 912. The supporting member 9121 may extend toward the locking member 920. The supporting member 9121 and the wall portion 912 may be integrally formed. The supporting member 9121 may be formed to support the first edge 922 adjacent to the rotation axis R of the locking member 920. When the locking member 920 rotates between the first position and the second position around the rotation axis R, the locking member 920 may be bent toward the wall portion 912 by stress or the like. The supporting member 9121 may support the first edge 922 of the locking member 920 to prevent such bending.

According to an embodiment, the supporting member 9121 may be positioned over the guideline portion 710 in a state in which the cable 700 and the connector 900 are normally connected. The supporting member 9121 may be positioned to vertically overlap the guideline portion 710 in a state in which the cable 700 and the connector 900 are normally connected. The guideline portion 710 and the supporting member 9121 may be positioned to be spaced apart from each other.

According to an embodiment, there may be a plurality of supporting members 9121. The plurality of supporting members 9121 may be spaced apart from each other by a predetermined distance. The plurality of supporting members 9121 may be spaced apart from each other by a predetermined distance in the length direction of the wall portion 912.

According to an embodiment, an end portion of the supporting member 9121 may be formed not to contact or contact the locking member 920. Even when the supporting member 9121 is not in contact with the locking member 920, when the locking member 920 is bent by rotating between the first position and the second position, the supporting member 9121 may contact the supporting member 9121 to prevent bending of the locking member 920.

According to an embodiment, the connector 900 may include a plurality of first terminals 930. The plurality of first terminals 930 may be disposed to penetrate the housing 910. For example, a plurality of first terminals 930 may be disposed to penetrate the wall portion 912 of the housing 910. Portions of a plurality of first terminals 930 may be exposed toward an upper side of the bottom portion 911.

According to an embodiment, portions of the plurality of first terminals 930 may be positioned to extend by the first length D3 along the bottom portion 911 vertically from the wall portion 912. Portions corresponding to the first length D3 of the plurality of first terminals 930 may be electrically connected by contacting the cable terminals 720 of the cable 700.

According to an embodiment, the connector 900 may include a plurality of second terminals 940. Some of a plurality of second terminals 940 may be positioned on the upper surface of the housing 910. The plurality of second terminals 940 may be disposed to extend from an upper surface of the wall portion 912 toward the locking member 920. The plurality of second terminals 940 may extend to be parallel to a plurality of first terminals 930.

According to an embodiment, a plurality of second terminals 940 may be disposed to press the locking member 920 in the lower direction. End portions of a plurality of second terminals 940 may be disposed to contact an upper surface of the locking member 920. Ends of a plurality of second terminals 940 may prevent the locking member 920 from being bent in the upper direction when the locking member 920 rotates between the first position and the second position.

According to an embodiment, the width D1 of the guideline portion 710 may be shorter than the first length D3. In an embodiment, the width D1 of the guideline portion 710 may be shorter than the length of the cable terminal 720. However, the disclosure is not limited to the above example embodiment.

According to an embodiment, when the cable 700 is normally connected to the connector 900, the guideline portion 710 may be positioned to vertically overlap a space (e.g., a gap G or an area) between the wall portion 912 and the first edge 922 adjacent to the rotation axis R of the locking member 920. The worker may visually identify the position of the guideline portion 710 through the gap G.

In the disclosure, the rotation axis R of the locking member 920 is spaced apart from the wall portion 912 of the housing 910 by a first distance D2 to form a gap G, so that the position of the guideline portion 710 may be identified with the naked eye of the worker through the gap G.

When penetrating to form a hole in the upper portion of the housing, an additional process for drilling the hole is required, and the size of the hole is also small, making it difficult for the worker to grasp the connection state of the cable in the housing through the hole. In the disclosure, by changing the structure of the connector 900 to form a gap G with a larger area, the worker may easily identify the position of the guideline portion 710 with the naked eye, so that a connector in a defective fastening state may be easily found.

FIGS. 4 and 6 illustrate a state before the cable 700 is connected to the connector 900. Before the cable 700 is connected to the connector 900, the locking member 920 may be positioned at a first position. The cable 700 may be electrically connected to the connector 900 by inserting the end portion where the guideline portion 710 is formed into the housing 910.

FIGS. 5 and 7 illustrate a state in which the cable 700 is normally connected to the connector 900. When the cable 700 is completely inserted into the housing 910, the locking member 920 may be rotated from the first position to the second position to fix the cable 700. In this case, the worker may determine whether the cable 700 is normally connected or fastened to the connector 900 based on whether the guideline portion 710 is visible through the gap G.

When the guideline portion 710 is not identified through the gap G when the locking member 920 is rotated to the second position after the cable 700 is inserted, the worker may determine that the cable 700 and the connector 900 are not connected normally, and may disconnect and reconnect the cable 700. Even when the guideline portion 710 is visible through the gap G, if only a portion is visible or the guideline portion 710 is viewed as being inclined, the worker may determine that the cable 700 and the connector 900 are not normally connected, and may disconnect the cable 700 and then reconnect the cable 700. Using the structure of the connector 900 and the cable 700 of the disclosure, the worker may intuitively determine whether the connector 900 and the cable 700 are normally fastened without a separate device. The disclosure is not limited to the above example embodiment, and by using the structure of the connector 900 and the cable 700, it may be possible to automate the process of identifying whether the fastening is done correctly using a vision sensor rather than a worker.

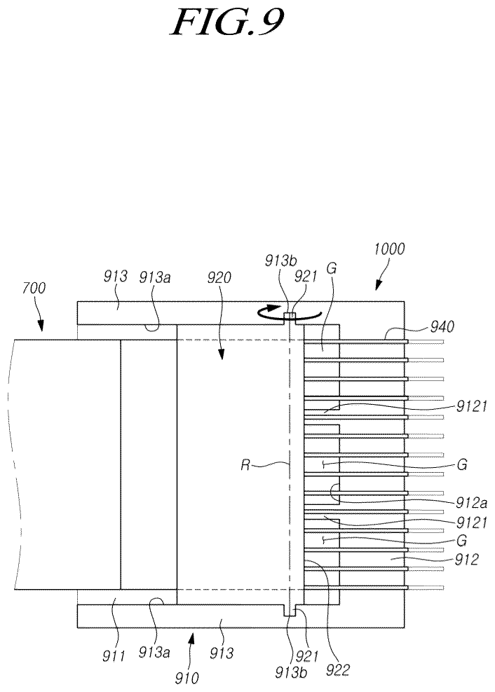

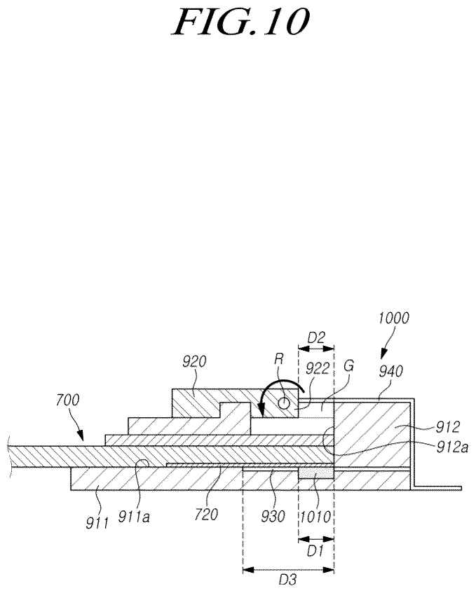

FIGS. 8 and 9 are plan views illustrating a connector according to an embodiment. FIG. 10 is a side view illustrating a connector according to an embodiment.

The connector 1000 of FIGS. 8 to 10 may be included in the display device 1 of FIGS. 1 and 2. However, the disclosure is not limited to the above example embodiment, and the connector 1000 of FIGS. 8 to 10 may be disposed in the electronic device to connect a cable (e.g., a flexible flat cable) in various types of electronic devices.

The embodiments of FIGS. 8 to 10 may be selectively combined with the embodiments of FIGS. 1 to 7.

The same reference numbers are used to denote substantially the same components as the components of FIGS. 3 to 7 among the components of FIGS. 8 to 10.

Referring to FIGS. 8 to 10, the connector 1000 may include a marking portion 1010. The marking portion 1010 may be disposed or printed on the housing 910. The marking portion 1010 may be disposed or printed on the bottom portion 911 of the housing 910.

According to an embodiment, the marking portion 1010 may be shown or printed along an edge of the wall portion 912 of the bottom portion 911. The marking portion 1010 may be shown or printed along a portion of the bottom portion 911 adjacent to the wall portion 912.

According to an embodiment, the marking portion 1010 may be shown or printed in a specific color. For example, the marking portion 1010 may be shown or printed in a high-contrast color compared to the surrounding components so that the worker or vision sensor may easily identify whether the cable 700 and the connector 1000 are connected or fastened normally. For example, the marking portion 1010 may be shown or printed in yellow, red, orange, fluorescent, white, or the like. However, the disclosure is not limited to the above example embodiment, and the marking portion 1010 may be shown or printed in a high-contrast color according to the color of the housing 910 or the locking member 920.

When the indication portion is directly shown on the housing 910 as in the disclosure, it may be possible to avoid marking the cable 700 with a separate check line or area for identifying whether to be fastened.

According to an embodiment, the marking portion 1010 may be positioned to vertically overlap the gap G. The worker may visually identify the marking portion 1010 through the gap G. In a state in which the cable 700 is not connected to the connector 1000, the worker may visually identify the marking portion 1010 through the gap G.

According to an embodiment, the width D1 of the marking portion 1010 may be equal to or longer than the first distance D2. Here, the width D1 may refer to a length of the marking portion 1010 measured along a direction in which the cable 700 is inserted.

According to an embodiment, the width D1 of the marking portion 1010 may be shorter than the first length D3 of the first terminal 930.

According to an embodiment, the supporting member 9121 may be positioned over the marking portion 1010.

Unlike the cables in FIGS. 3 to 7, the cable 700 in FIGS. 8 to 10 may omit the guideline portion (e.g., the guideline portion 710 in FIG. 3). However, the disclosure is not limited to the above example embodiment, and the cable 700 of FIGS. 8 to 10 may also be provided with the guideline portion (710 of FIGS. 3 to 7).

FIG. 8 illustrates a state before the cable 700 is connected to the connector 1000. Before the cable 700 is connected to the connector 1000, the locking member 920 may be positioned at a first position. The cable 700 may be electrically connected to the connector 1000 by being inserted into the housing 910.

FIGS. 9 and 10 illustrate a state in which the cable 700 is normally connected to the connector 1000. When the cable 700 is completely inserted into the housing 910, the locking member 920 may be rotated from the first position to the second position to fix the cable 700. In this case, the worker may determine whether the cable 700 is normally connected or fastened to the connector 1000 based on whether the marking portion 1010 is visible through the gap G.

When the marking portion 1010 is visible through the gap G when the locking member 920 is rotated to the second position after the cable 700 is inserted, the worker may determine that the cable 700 and the connector 1000 are not connected normally, and may disconnect and reconnect the cable 700. Even when only a portion of the marking portion 1010 is visible through the gap G, the worker determines that the cable 700 and the connector 1000 are not normally connected, and may disconnect the cable 700 and then reconnect the cable 700. The worker may intuitively determine whether the connector 1000 and cable 700 are normally fastened without needing a separate device, by using the connector 1000 of the disclosure. The disclosure is not limited to the above example embodiment, and by using the structure of the connector 900, it may be possible to automate the process of identifying whether the fastening is done correctly using a vision sensor rather than a worker.

According to an embodiment, a display device may comprise a display module 400, a PCB electrically connected to the display module 400, a connector 900 disposed on the PCB, and a cable 700 extending from the display module 400 and connected to the connector 900, and including a plurality of cable terminals 720 and a guideline portion 710 marked at an end portion on a side of the connector 900. The connector 900 may include a housing 910 including a bottom portion 911 contacting the PCB and a wall portion 912 extending upward from the bottom portion 911 and formed adjacent to the guideline portion 710, and a locking member 920 rotatably or pivotally coupled to the housing 910 about a rotation axis R. An edge of the locking member 920 adjacent to the rotation axis R may be spaced apart from the wall portion 912 by a first distance D2.

According to an embodiment, a width D1 of the guideline portion 710 may be equal to or longer than the first distance D2.

According to an embodiment, the rotation axis R of the locking member 920 may be positioned to extend in a direction parallel to a length direction of the wall portion 912.

According to an embodiment, the housing 910 may further include a supporting member 9121 extending from the wall portion 912 toward the locking member 920 to support an edge of the locking member 920 adjacent to the rotation axis R.

According to an embodiment, the supporting member 9121 may be positioned above the guideline portion 710.

According to an embodiment, the connector 900 may include a plurality of first terminals extending by a first length D3 vertically from the wall portion 912 along the bottom portion 911 to be electrically connected to the cable 700. A width D1 of the guideline portion 710 may be shorter than the first length D3.

According to an embodiment, the connector 900 may have a gap between an edge of the locking member 920 adjacent to the rotation axis R and the wall portion 912.

According to an embodiment, the cable 700 may be a flexible flat cable (FFC).

According to an embodiment, the guideline portion 710 may be marked in a specific color.

According to an embodiment, when the cable 700 is connected to the connector 900, the guideline portion 710 may be positioned to vertically overlap a space (or a gap, an area) between an edge of the locking member 920 adjacent to the rotation axis R and the wall portion 912.

A display device 1 according to an embodiment of the disclosure may comprise a display module 400, a PCB electrically connected to the display module 400, a connector 1000 disposed on the PCB, and a cable 700 extending from the display module 400 and connected to the connector 1000. The cable 700 may include a plurality of cable terminals and a guideline portion marked at an end portion on a side of the connector 1000. The connector 1000 may include a housing 910 including a bottom portion 911 contacting the PCB and a wall portion 912 extending upward from the bottom portion 911 and formed adjacent to the guideline portion 710, and a locking member 920 rotatably or pivotally coupled to the housing 910 about a rotation axis R. An edge of the locking member 920 adjacent to the rotation axis R may be spaced apart from the wall portion 912 by a first distance D2 to form a first gap. The housing 910 may further include a marking portion 1010 marked on an upper surface of the bottom portion 911 to at least partially overlap vertically the first gap.

According to an embodiment, the marking portion 1010 may be marked along an edge of the bottom portion 911 on a side of the wall portion 912.

According to an embodiment, the housing 910 may further include a supporting member 9121 extending from the wall portion 912 toward the locking member 920 to support an edge of the locking member 920 adjacent to the rotation axis R.

According to an embodiment, the supporting member 9121 may be positioned above the marking portion 1010.

According to an embodiment, the cable 700 may be a flexible flat cable (FFC).

A connector to which a cable 700 including a plurality of cable terminals may be connected, according to an embodiment, may comprise a housing 910 including a bottom portion 911 on which a plurality of first terminals may be disposed, and a wall portion 912 formed to extend upward from an edge of the bottom portion 911 where the plurality of first terminals may be disposed, and a locking member 920 rotatably or pivotally coupled to the housing 910 about a rotation axis R. An edge of the locking member 920 adjacent to the rotation axis R may be spaced apart from the wall portion 912 by a first distance D2.

According to an embodiment, a width D1 of the guideline portion 710 may be equal to or longer than the first distance D2.

According to an embodiment, the rotation axis R of the locking member 920 may be disposed to extend in a direction parallel to a length direction of the wall portion 912.

According to an embodiment, the housing 910 may further include a supporting member 9121 extending from the wall portion 912 toward the locking member 920 to support an edge of the locking member 920 adjacent to the rotation axis R. The supporting member 9121 may be positioned above the guideline portion 710.

According to an embodiment, the connector may further comprise a plurality of second terminals partially extending vertically from the wall portion 912 along the bottom portion 911 by a first length D3 to be electrically connected to the cable 700. A width D1 of the guideline portion 710 may be shorter than the first length D3.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ encompasses any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but covers all various modifications, equivalents, and/or substitutes of one or more embodiments.

What is claimed is:

1. A display device comprising:
a display module;
a printed circuit board electrically connected to the display module;
a connector on the printed circuit board; and
a cable extending from the display module and connected to the connector,
wherein the cable comprises a plurality of cable terminals and a guideline portion positioned at an end portion of the cable and on a side of the connector,
wherein the connector comprises:
a housing comprising a bottom portion contacting the printed circuit board and a wall portion extending upward from the bottom portion and being adjacent to the guideline portion, and
a locking member pivotally coupled to the housing about a rotation axis (R), and
wherein an edge of the locking member adjacent to the rotation axis (R) is spaced apart from the wall portion by a first distance (D2).

2. The display device of claim 1, wherein a width (D1) of the guideline portion is equal to or longer than the first distance (D2).

3. The display device of claim 1, wherein the rotation axis (R) of the locking member extends in a direction parallel to a length direction of the wall portion.

4. The display device of claim 1, wherein the housing further comprises a supporting member extending from the wall portion toward the locking member and supporting the edge of the locking member adjacent to the rotation axis (R).

5. The display device of claim 4, wherein the supporting member is positioned above the guideline portion.

6. The display device of claim 1, wherein the connector comprises a plurality of first terminals extending by a first length (D3) vertically from the wall portion along the bottom portion and being electrically connected to the cable, and
wherein a width (D1) of the guideline portion is shorter than the first length (D3).

7. The display device of claim 1, wherein the connector has a gap between an edge of the locking member adjacent to the rotation axis (R) and the wall portion.

8. The display device of claim 1, wherein the cable is a flexible flat cable (FFC).

9. The display device of claim 1, wherein the guideline portion is marked in a specific color.

10. The display device of claim 1, wherein the cable is connected to the connector, and
wherein the guideline portion vertically overlaps a space between the edge of the locking member adjacent to the rotation axis (R) and the wall portion.

11. A display device comprising:
a display module;
a printed circuit board electrically connected to the display module;
a connector on the printed circuit board; and
a cable extending from the display module and connected to the connector,
wherein the cable comprises a plurality of cable terminals and a guideline portion positioned at an end portion of the cable and on a side of the connector,
wherein the connector comprises:
a housing comprising a bottom portion contacting the printed circuit board and a wall portion extending upward from the bottom portion and being adjacent to the guideline portion; and
a locking member pivotally coupled to the housing about a rotation axis (R),
wherein an edge of the locking member adjacent to the rotation axis (R) is spaced apart from the wall portion by a first distance (D2) to form a first gap, and
wherein the housing further comprises a marking portion marked on an upper surface of the bottom portion to at least partially and vertically overlap the first gap.

12. The display device of claim 11, wherein the marking portion is marked along an edge of the bottom portion on a side of the wall portion.

13. The display device of claim 11, wherein the housing further comprises a supporting member extending from the wall portion toward the locking member and supporting an edge of the locking member adjacent to the rotation axis (R).

14. The display device of claim 13, wherein the supporting member is positioned above the marking portion.

15. The display device of claim 13, wherein the cable is a flexible flat cable (FFC).

16. A connector to which a cable comprising a plurality of cable terminals is connected, the connector comprising:
a housing comprises a bottom portion on which a plurality of first terminals are disposed, and a wall portion extending upward from an edge of the bottom portion; and
a locking member pivotally coupled to the housing about a rotation axis (R),
wherein the edge of the locking member adjacent to the rotation axis (R) is spaced apart from the wall portion by a first distance (D2).

17. The connector of claim 16, wherein a width (D1) of a guideline portion is equal to or longer than the first distance (D2).

18. The connector of claim 16, wherein the rotation axis (R) of the locking member extends in a direction parallel to a length direction of the wall portion.

19. The connector of claim 16, wherein the housing further comprises a supporting member extending from the wall portion toward the locking member and supporting an edge of the locking member adjacent to the rotation axis (R), and
wherein the supporting member is above a guideline portion.

20. The connector of claim 16, wherein the connector further comprises a plurality of second terminals partially and vertically extending from the wall portion along the bottom portion by a first length (D3) and being electrically connected to the cable, and
wherein a width (D1) of the guideline portion is shorter than the first length (D3).
